(19) United States
(12) Patent Application Publication
(10) Pub. No.: US 2018/0032190 A1
(43) Pub. Date: Feb. 1, 2018

(54) DISPLAY DEVICE

(71) Applicant: Japan Display Inc., Minato-ku (JP)

(72) Inventor: Gen KOIDE, Tokyo (JP)

(73) Assignee: Japan Display Inc., Minato-ku (JP)

(21) Appl. No.: 15/658,743

(22) Filed: Jul. 25, 2017

(30) Foreign Application Priority Data
Jul. 29, 2016 (JP) 2016-149576

(51) Int. Cl. G06F 3/041; G02F 1/1368; G02F 1/1362; G02F 1/1345; G02F 1/1343; G06F 3/044; G02F 1/1333

(52) U.S. Cl. CPC G06F 3/0412; G06F 3/0416; G06F 3/044; G02F 1/1368; G02F 1/13338; G02F 1/13452; G02F 1/13458; G02F 1/134309; G02F 1/136286; G06F 2203/04111; G02F 1/133514

(57) ABSTRACT

According to one embodiment, a display device includes a first substrate, a second substrate, a first connection hole, and a connecting member. The first substrate includes a first insulating substrate, a drive electrode, a first conductive layer, a first lead, and a first inspection circuit. The second substrate includes a second insulating substrate, and a first detection electrode. The first connection hole penetrates the second insulating substrate. The connecting member electrically connects the first detection electrode with the first conductive layer via the first connection hole.

### CROSS-REFERENCE TO RELATED APPLICATIONS

This application is based upon and claims the benefit of priority from Japanese Patent Application No. 2016-149576, filed Jul. 29, 2016, the entire contents of which are incorporated herein by reference.

### FIELD

Embodiments described herein relate generally to a display device.

### BACKGROUND

Recently, various technologies of forming a display device in a narrower frame shape have been reviewed. For example, a technology of electrically connecting a line portion including an in-hole connecting portion inside a hole penetrating an inner surface and an outer surface of a first substrate formed of resin with a line portion provided on an inner surface of a second substrate formed of resin, by an inter-substrate connecting portion, has been disclosed.

### BRIEF DESCRIPTION OF THE DRAWINGS

FIG. 1 is a plan view showing a configuration of the display device according to an embodiment.

FIG. 2 is a cross-sectional view showing a configuration example of the display device according to the embodiment.

FIG. 3 is a plan view showing a configuration example of the display device according to the embodiment.

FIG. 4 is a diagram showing a basic configuration and an equivalent circuit, of the display panel shown in FIG. 3.

FIG. 5 is a cross-sectional view showing a partial configuration of the display panel shown in FIG. 3.

FIG. 6 is a plan view showing a configuration example of a sensor.

FIG. 7 is a plan view showing another configuration example of the display device according to the embodiment.

FIG. 8 is an illustration showing a configuration example of a detector in a detection electrode shown in FIG. 3 and FIG. 7.

FIG. 9 is a cross-sectional view showing the display panel including a connection hole shown in FIG. 3 as sectioned in line IX-IX.

FIG. 10 is a plan view showing the display device according to the embodiment together with an inspection device of the display panel.

FIG. 11 is a plan view showing several parts of a first substrate according to the embodiment.

FIG. 12 is another plan view showing several parts of the first substrate according to the embodiment.

FIG. 13 is a cross-sectional view showing the first substrate along line XIII-XIII in FIG. 12.

FIG. 14 is a plan view showing a modified example of the display panel according to the embodiment.

### DETAILED DESCRIPTION

In general, according to one embodiment, there is provided a display device comprising: a first substrate including a first insulating substrate, a drive electrode located in a display area, a first conductive layer located in a non-display area outside the display area, a first lead located in the non-display area and connected to the first conductive layer, and a first inspection circuit located in the non-display area and connected to the first lead; a second substrate including a second insulating substrate opposed to the first insulating substrate and the drive electrode, and a first detection electrode opposed to the first conductive layer to intersect the drive electrode; a first connection hole penetrating the second insulating substrate; and a connecting member electrically connecting the first detection electrode with the first conductive layer via the first connection hole.

One of embodiments will be described hereinafter with reference to the accompanying drawings. The disclosure is merely an example, and proper changes in keeping with the spirit of the invention, which are easily conceivable by a person of ordinary skill in the art, come within the scope of the invention as a matter of course. In addition, in some cases, in order to make the description clearer, the widths, thicknesses, shapes and the like, of the respective parts are illustrated schematically in the drawings, rather than as an accurate representation of what is implemented. However, such schematic illustration is merely exemplary, and in no way restricts the interpretation of the invention. In addition, in the specification and drawings, the same elements as those described in connection with preceding drawings are denoted by like reference numbers, and detailed description thereof is omitted unless necessary.

In each of the embodiments, a display device comprising a display panel using a liquid crystal display element is disposed as an example of the display device. However, each embodiment does not prevent application of individual technical ideas disclosed in each embodiment to display devices using display elements other than the liquid crystal display elements. As the display panels other than the liquid crystal display panels, a self-luminous display panel comprising an organic electroluminescent display element and the like or an electronic paper display panel comprising an electrophoresis element and the like is supposed.

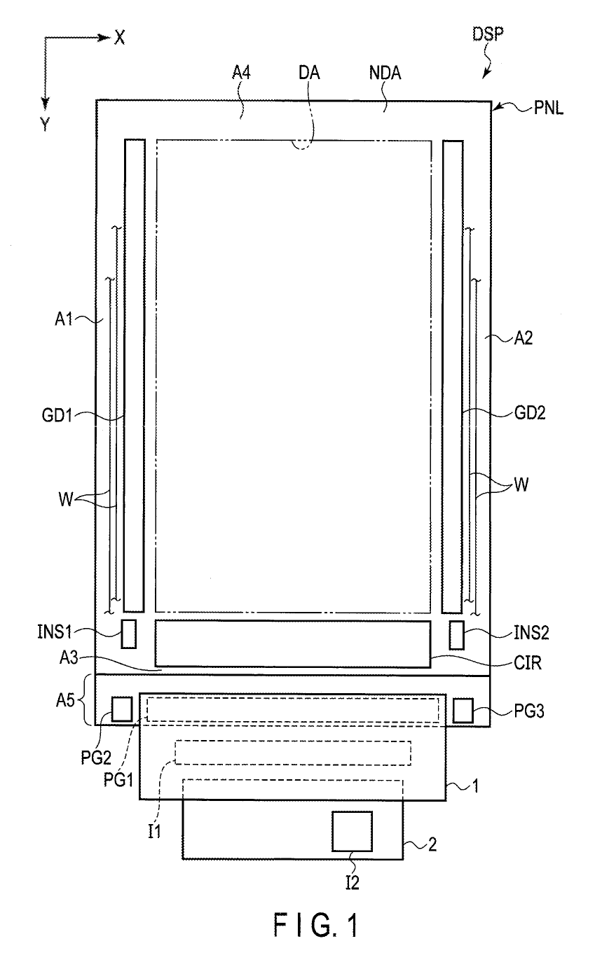

FIG. 1 is a plan view showing a configuration of the display device according to an embodiment. In the present embodiment, the first direction X and the second direction Y are orthogonal to each other. The direction mentioned here is a direction indicated by an arrow in the drawing, and a direction reversed from an arrow at 180 degrees is called an opposite direction. The first direction X and the second direction Y may intersect at an angle other than 90 degrees.

As shown in FIG. 1, the display device DSP comprises an active-matrix display panel PNL, wiring substrates 1 and 2, IC chips I1 and I2, and the like. The display panel PNL comprises a first substrate SUB1 and a second substrate SUB2 opposed to the first substrate SUB1. In the present embodiment, the first substrate SUB1 is formed in a quadrangular shape, and the second substrate SUB2 is formed in a quadrangular shape having an outline smaller than the first substrate SUB1. In the example shown in the drawing, the first substrate SUB1 and the second substrate SUB2 are superposed on three sides.

The display panel PNL includes a display area DA in which an image is displayed and a frame-shaped non-display area NDA surrounding the display area DA.

In the non-display area NDA, an area on the left side of the display area DA, which is in a strip shape extending in the second direction Y, is called a first area A1, an area on the right side of the display area DA, which is in a strip shape extending in the second direction Y, is called a second area A2, an area on the lower side of the display area DA, which is in a strip shape extending in the first direction X, is called a third area A3, and an area on the upper side of the display area DA, which is in a strip shape extending in the first direction X, is called a fourth area A4. The third area A3 includes an unopposed area A5 in which the first substrate SUB1 is not opposed to the second substrate SUB2.

The display panel PNL comprises scanning line drive circuits GD1 and GD2, a circuit group CIR, inspection circuits INS1 and INS2, a first pad group PG1, a second pad group PG2, and a third pad group PG3. The scanning line drive circuits GD1 and GD2 are configured to drive scanning lines which will be explained later, the scanning line drive circuit GD1 is disposed in the first area A1, and the scanning line drive circuit GD2 is disposed in the second area A2.

A plurality of leads W are disposed in the non-display area NDA of the first substrate SUB1. In the first area A1, the leads W are located on the outside of the first substrate SUB1 from the scanning line drive circuit GD1. In the second area A2, the leads W are located on the outside of the first substrate SUB1 from the scanning line drive circuit GD2. In other words, the scanning line drive circuit GD1 is located on the display area DA side of the leads W in the first area A1, and the scanning line drive circuit GD2 is located on the display area DA side of the leads W in the second area A2. The leads W will be described in detail later.

The circuit group CIR is disposed in the third area A3. The circuit group CIR includes a plurality of circuits such as a common electrode drive circuit for driving a common electrode which will be explained later, and the like. In the present embodiment, the common electrode is often called a sensor drive electrode.

The inspection circuits INS1 and INS2 can be employed for inspection of detection electrodes which will be explained later. The inspection circuit INS1 is disposed in the first area A1 and the inspection circuit INS2 is disposed in the second area A2. However, the inspection circuits INS1 and INS2 may be disposed in the non-display area NDA, disposed in the third area A3, disposed across the first area A1 and the third area A3, or disposed across the second area A2 and the third area A3.

The first pad group PG1, the second pad group PG2, and the third pad group PG3 are outer lead bonding pad groups and disposed in the unopposed area A5. In the present embodiment, the second pad group PG2, the first pad group PG1, and the third pad group PG3 are arranged in this order in the first direction X and spaced apart from each other.

In the present embodiment, pads included in the first pad group PG1 are electrically connected to the scanning line drive circuits GD1 and GD2, the circuit group CIR, and the inspection circuits INS1 and INS2. Pads included in the second pad group PG2 are electrically connected to the inspection circuit INS1 while pads included in the third pad group PG3 are electrically connected to the inspection circuit INS2.

A wiring substrate 1 is physically connected to the unopposed area A5 of the first substrate SUB1, and electrically connected to the pads of the first pad group PG1. The IC chip I1 is mounted on the wiring substrate 1. The IC chip I1 can supply signals to the scanning line drive circuits GD1 and GD2, the circuit group CIR, and the inspection circuit INS1 and INS2 via the wiring substrate 1, the first pad group PG1 and the like.

A wiring substrate 2 is connected to the wiring substrate 1. The wiring substrate 2 may be connected to a control module (not shown). The IC chip I2 is mounted on the wiring substrate 2. The IC chip I2 can receive signals from the detection electrodes via the wiring substrate 2, the wiring substrate 1, the first pad group PG1 and the like.

The wiring substrates 1 and 2 are, for example, flexible substrates having flexibility. A flexible substrate applicable to the present embodiment is a flexible substrate which at least partially includes a flexible portion formed of a flexible material. For example, the wiring substrates 1 and 2 of the present embodiment may be a flexible substrate which is entirely formed as a flexible portion, or may also be a rigid flexible substrate which includes a rigid portion formed of a hard material such as glass epoxy and a flexible portion formed of a flexible material such as polyimide.

The display panel PNL is, for example, a transmissive liquid crystal display panel which has a transmissive display function of displaying an image by selectively transmitting light from the lower side of the first substrate SUB1. Alternatively, the display panel PNL may be a reflective liquid crystal display panel which has a reflective display function of displaying an image by selectively reflecting light from above the second substrate SUB2. Alternatively, the display panel PNL may be a transreflective liquid crystal display panel comprising the transmissive display function and a reflective display function. If the display panel PNL is a transmissive liquid crystal display panel or a transreflective liquid crystal display panel, the display device DSP comprises an illumination device disposed on a back surface of the first substrate SUB1.

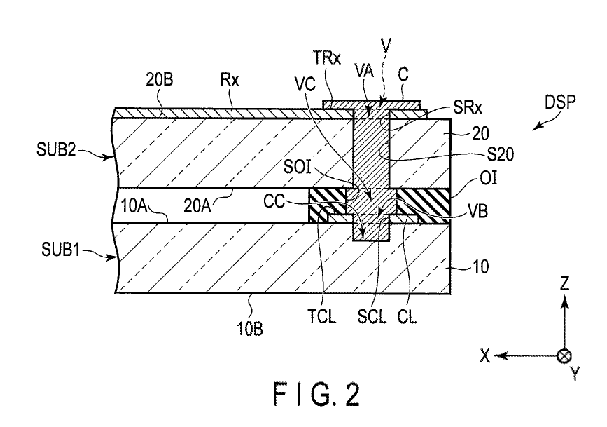

Next, an example of a configuration concerning connection between a conductive layer on the first substrate SUB1 side and an electrode on the second substrate SUB2 side will be explained. FIG. 2 is a cross-sectional view showing a configuration example of the display device DSP according to the embodiment.

As shown in FIG. 2, a third direction Z is orthogonal to each of the first direction X and the second direction Y shown in FIG. 1. The third direction Z corresponds to a thickness direction of the display device DSP. In the following explanation, a direction from the first substrate SUB1 toward the second substrate SUB2 is referred to as upward (or merely above), and a direction from the second substrate SUB2 toward the first substrate SUB1 is referred to as downward (or merely below). In addition, according to “the second member above the first member” and “the second member below the first member”, the second member may be in contact with the first member or may be located to be remote from the first member. In the latter case, a third member may be interposed between the first member and the second member. A view from the second substrate SUB2 to the first substrate SUB1 is called a planar view.

The display device DSP comprises the first substrate SUB1, the second substrate SUB2, and the connecting member C. The first substrate SUB1 and the second substrate SUB2 are opposed to each other in the third direction Z.

The first substrate SUB1 includes a first glass substrate 10 serving as an insulating substrate and a conductive layer CL located on a side of the first glass substrate 10 which is opposed to the second substrate SUB2. The first glass substrate 10 has a main surface 10A opposed to the second substrate SUB2 and a main surface 10B on a side opposite to the main surface 10A. In the example illustrated, the conductive layer CL is located on the main surface 10A. Various insulating films and various conductive films may be disposed between the first glass substrate 10 and the conductive layer CL or on the conductive layer CL, although not illustrated in the drawing.

The second substrate SUB2 includes a second glass substrate 20 serving as an insulating substrate and detection electrodes Rx. The second glass substrate 20 has a main surface 20A opposed to the first substrate SUB1 and a main surface 20B on a side opposite to the main surface 20A. The main surface 20A of the second glass substrate 20 is opposed to the conductive layer CL and remote from the conductive layer CL in the third direction Z. In the example illustrated, the detection electrodes Rx are located on the main surface 20B. The first glass substrate 10, the conductive layer CL, the second glass substrate 20, and the detection electrode Rx are arranged in this order in the third direction Z. An organic insulating film OI is located between the conductive layer CL and the second glass substrate 20. The organic insulating film OI in the above includes, for example, a light-shielding layer, a color filter, an overcoat layer, an alignment film, a sealing member which bonds the first substrate SUB1 and the second substrate SUB2, which will be described later, and the like. Various insulating films or various conductive films may be disposed between the second glass substrate 20 and the detection electrodes Rx or on the detection electrodes Rx, although not illustrated in the drawing. Various insulating films or various conductive films may also be disposed between the first substrate SUB1 and the second substrate SUB2.

The first glass substrate 10 and the second glass substrate 20 are formed of, for example, an insulating material such as alkali-free glass. The conductive layer CL and the detection electrode Rx are formed of, for example, metallic materials such as molybdenum, tungsten, titanium, aluminum, silver, copper and chromium, an alloy of a combination of these metallic materials, transparent conductive materials such as indium tin oxide (ITO) and indium zinc oxide (IZO) and the like, and may be formed in a single-layer structure or a multi-layer structure. The connecting member C desirably contains a metallic material such as silver and also contains fine particles having the size of order of several nanometers to several tens of nanometers.

A connection structure of the conductive layer CL and the detection electrode Rx in the present embodiment will be described in detail. In the second substrate SUB2, the second glass substrate 20 includes a through hole (first through hole) VA penetrating between the main surfaces 20A and 20B. In the example illustrated, the through hole VA also penetrates the detection electrode Rx. In contrast, in the first substrate SUB1, the conductive layer CL includes a through hole (second through hole) VB opposed to the through hole VA in the third direction Z. In addition, the first glass substrate 10 includes a concavity CC opposed to the through hole VB in the third direction Z.

The organic insulating film OI includes a through hole (third through hole) VC connected to the through holes VA and VB. In the example illustrated, the through hole VC is expanded in the first direction X as compared with the through holes VA and VB. The through hole VC is more expanded than the through holes VA and VB not only in the first direction X, but in all directions in the X-Y plane. The concavity CC, the through hole VB, the through hole VC and the through hole VA are arranged in this order in the third direction Z.

The concavity CC is formed toward the main surface 10B from the main surface 10A, but does not penetrate to reach the main surface 10B in the example illustrated. For example, a depth of the concavity CC in the third direction Z is approximately one fifth to approximately a half of the thickness of the first glass substrate 10 in the third direction Z. The first glass substrate 10 may include a through hole penetrating between the main surfaces 10A and 10B instead of the concavity CC. The through hole VB and the concavity CC are located directly under the through holes VA and VC. The through holes VA, VC, and VB, and the concavity CC are located in the same straight line along the third direction Z to form a connection hole V.

The connecting member C electrically connects the detection electrode Rx with the conductive layer CL via the through holes VA, VB, and VC. In the example illustrated, the connecting member C is in contact with each of an upper surface TRx of the detection electrode Rx, an inner surface SRx of the detection electrode Rx in the through hole VA, and an inner surface S20 of the second glass substrate 20 in the through hole VA, in the second substrate SUB2. In addition, the connecting member C is in contact with each of an inner surface SCL of the conductive layer CL in the through hole VB, an upper surface TCL of the conductive layer CL, and the concavity CC, in the first substrate SUB1.

The connecting member C is in contact with an inner surface SOI of the organic insulating film OI in the through hole VC. In the example illustrated, the through holes VA, VB, and VC and the concavity CC are filled with the connecting member C so as to be buried but the connecting member C may be provided on at least the inner surfaces of the holes and the concavity. The connecting member C is formed continuously between the conductive layer CL and the detection electrode Rx.

The detection electrode Rx is thereby electrically connected with the wiring substrate 2 via the connecting member C, the conductive layer CL and the like. For this reason, the control circuit configured to write a signal to the detection electrode Rx and read a signal output from the detection electrode Rx can be connected to the detection electrode Rx via the wiring substrate 2. In other words, a wiring substrate other than the wiring substrates 1 and 2 does not need to be mounted on the second substrate SUB2.

As explained above, according to the configuration of connecting the conductive layer CL on the first substrate SUB1 side with the detection electrode Rx on the second substrate SUB2 side, a terminal to mount the other wiring substrate and a routing line to connect the detection electrode Rx with the other wiring substrate are unnecessary. The size of the second substrate SUB2 can be therefore reduced in the X-Y plane defined by the first direction X and the second direction Y. Alternatively, the frame width of the periphery of the display device DSP can be reduced. The display device can be thereby designed in a narrower frame shape.

In addition, since the connecting member C is in contact with not only the inner surface SCL of the conductive layer CL in the through hole VB but also the upper surface TCL of the conductive layer CL, a contact area of the connecting member C on the conductive layer CL can be increased and connection failure between the connecting member C and the conductive layer CL can be suppressed.

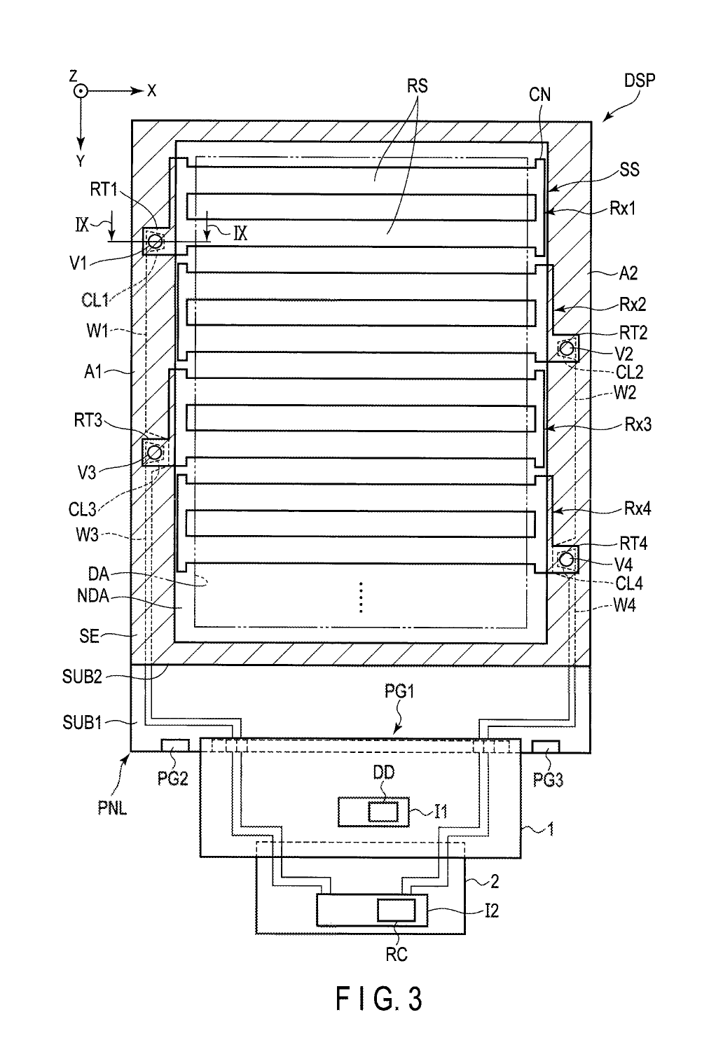

FIG. 3 is a plan view showing a configuration example of the display device DSP according to the embodiment. A liquid crystal display device equipped with a sensor SS will be described as an example of the display device DSP.

The display device DSP includes a display panel PNL, IC chips I1 and I2, the wiring substrates 1 and 2, and the like. The display panel PNL is a liquid crystal display panel, which includes a first substrate SUB1, a second substrate SUB2, a sealing member SE and a display function layer (a liquid crystal layer LC to be explained later). The second substrate SUB2 is opposed to the first substrate SUB1. The sealing member SE corresponds to a portion represented by upward-sloping hatch lines in FIG. 3 to bond the first substrate SUB1 to the second substrate SUB2. The sealing member SE is located in the non-display area NDA. The display area DA is located on an inner side surrounded by the sealing member SE.

The IC chip I1 is mounted on the wiring substrate 1 and the IC chip I2 is mounted on the wiring substrate 2, but the IC chips I1 and I2 are not limited to the example illustrated and may be mounted on an external circuit substrate. The IC chip I1 incorporates, for example, a display driver DD which outputs a signal necessary to display an image. The display driver DD includes at least some of a signal line drive circuit SD, a scanning line drive circuit GD and a common electrode drive circuit CD which will be explained later. In the example illustrated, the IC chip I2 incorporates a detection circuit RC which functions as a touch panel controller or the like. The IC chip I2 is connected to the pads of the first pad group PG1 via the wiring substrate 2 and the wiring substrate 1. The detection circuit RC may be incorporated in the IC chip I1.

The sensor SS senses an object to be detected being in contact with or in proximity to the display device DSP. The sensor SS comprises a plurality of detection electrodes Rx (Rx1, Rx2, . . . ). The detection electrodes Rx are disposed on the second substrate SUB2. The detection electrodes Rx extend in the first direction X and are arranged to be spaced apart in the second direction Y. In FIG. 3, detection electrodes Rx1 to Rx4 are illustrated as the detection electrodes Rx, and the detection electrode (first detection electrode) Rx1 will be noted and its structural example will be explained here.

The detection electrode Rx1 comprises detectors RS, a terminal RT1 and a connector CN.

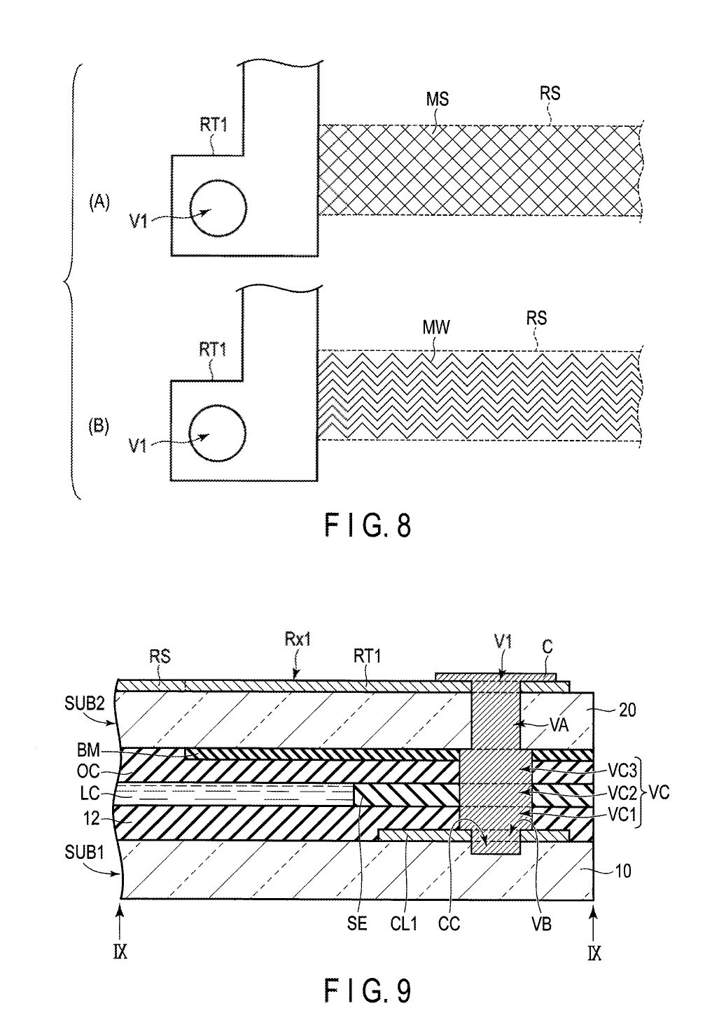

The detectors RS are located in the display area DA and extend in the first direction X. In the detection electrode Rx1, the detectors RS are mainly used for sensing. In the example illustrated, each detector RS is formed in a strip shape and, more specifically, formed of an assembly of fine metal wires as explained with reference to FIG. 8. One detection electrode Rx1 comprises two detectors RS but may comprise three or more detectors RS or one detector RS.

The terminal RT1 is located in the first area A1 of the non-display area NDA and is connected to the detectors RS. The connector CN is located in the second area A2 of the non-display area NDA to connect the detectors RS to each other. A part of the terminal RT1 is formed at a position superposed on the sealing member SE in planar view.

In contrast, the first substrate SUB1 includes a plurality of conductive layers CL (CL1, CL2, . . . ) corresponding to the above conductive layer CL, and a plurality of leads W (W1, W2, . . . ) corresponding to the above lead W. The conductive layer (first conductive layer) CL1 and the lead (first lead) W1 are located in the first area A1 and superposed on the sealing member SE in planar view. The conductive layer CL1 is formed at a position superposed on the terminal RT1 in a planar view. The lead W1 is connected to the conductive layer CL1 to extend in the second direction Y, and is electrically connected with the detection circuit. RC of the IC chip I2 via the first pad group PG1 and the wiring substrates 1 and 2.

A plurality of connection holes V (V1, V2, . . . ) are formed on the display panel PNL. A connection hole (first connection hole) V1 is formed at a position at which the terminal RT1 is opposed to the conductive layer CL1. In addition, the connection hole V1 may penetrate the second substrate SUB2 including the first terminal RT1, and the sealing member SE, and may also penetrate the conductive layer CL1. In the example illustrated, the contact hole V1 is formed in a circular shape in planar view, the shape is not limited to the example illustrated but may be the other shapes such as an elliptic shape. As explained with reference to FIG. 1 and the like, the connecting member C is provided in the contact hole V1. The terminal RT1 and the conductive layer CL1 are thereby electrically connected to each other. In other words, the detection electrode Rx1 disposed on the second substrate SUB2 is electrically connected with the detection circuit RC via the wiring substrates 1 and 2 connected to the first substrate SUB1. The detection circuit RC reads a sensor signal which is output from the detection electrode Rx, and detects the presence or absence of contact or approach of an object to be detected, the position coordinates of an object to be detected, and the like.

In the example illustrated, the terminals RT1 and RT3 of the odd-numbered detection electrodes Rx1 and Rx3 such as the detection electrode Rx1, the detection electrode (third detection electrode) Rx3, the conductive layer CL1, the conductive layer (third conductive layer) CL3, the lead W1, the lead (third lead) W3, the connection hole V1, the connection hole (third connection hole) V3, and the like are located in the first area A1 of the non-display area NDA. In addition, the terminals RT2 and RT4 of the even-numbered detection electrodes Rx2 and Rx4 such as the detection electrode (second detection electrode) Rx2, the detection electrode (fourth detection electrode) Rx4, the conductive layer (second conductive layer) CL2, the conductive layer (fourth conductive layer) CL4, the lead (second lead) W2, the lead (fourth lead) W4, the connection hole (second connection hole) V2, the connection hole (fourth connection hole) V4, and the like are located in the second area A2 of the non-display area NDA. According to this layout, a width of the first area A1 and a width of the second area A2 can be made equal and the frame can be desirably narrowed.

As illustrated in the drawing, the lead W1 is disposed to bypass the inside of the conductive layer CL3 (i.e., the side close to the display area DA) and to be arranged on the inside of the lead W3 between the conductive layer CL3 and the first pad group PG1, in the layout in which the conductive layer CL3 is closer to the first pad group PG1 than the conductive layer CL1. Similarly, the lead W2 is disposed to bypass the inside of the conductive layer CL4 and to be arranged on the inside of the lead W4 between the conductive layer CL4 and the first pad group PG1.

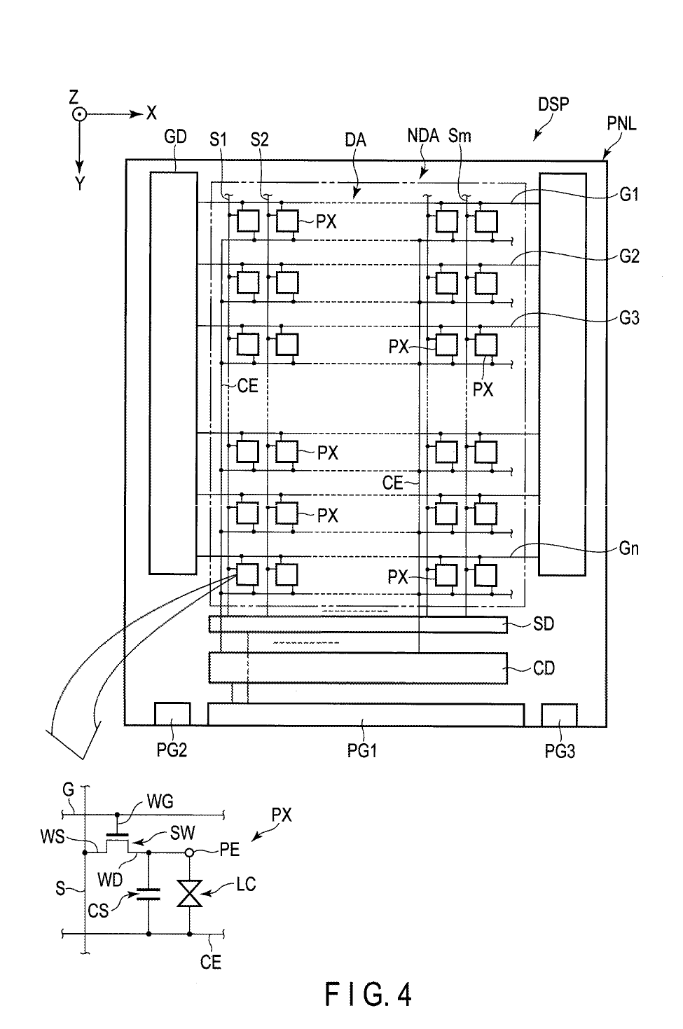

FIG. 4 is a diagram showing a basic configuration and an equivalent circuit, of the display panel PNL shown in FIG. 3.

As shown in FIG. 4, the display panel PNL includes a plurality of pixels PX in the display area DA. The pixel indicates a minimum unit which can be controlled independently in accordance with the pixel signal and exists in a region including, for example, switching element disposed at position where scanning line and signal line to be explained later intersect. The pixels PX are arranged in a matrix in the first direction X and the second direction Y. In addition, the display panel PNL includes a plurality of scanning lines G (G1 to Gn), a plurality of signal lines S (S1 to Sm), common electrodes CE and the like in the display area DA. The scanning lines G extend in the first direction X and are arranged in the second direction Y. The signal lines S extend in the second direction Y and are arranged in the first direction X. The scanning lines G and the signal lines S do not necessarily extend linearly but may be partially bent. The common electrodes CE are arranged over the pixels PX. The scanning lines G, the signal lines S and the common electrodes CE are drawn to the non-display area NDA. In the non-display area NDA, the scanning lines G are connected to the scanning line drive circuits GD1 and GD2, the signal lines S are connected to the signal line drive circuit SD, and the common electrodes CE are connected to the common electrode drive circuit CD.

Each of the scanning lines G is connected to both the scanning line drive circuits GD1 and GD2, but may be connected to any one of the scanning line drive circuits GD1 and GD2. For example, odd-numbered scanning lines G may be connected to the scanning line drive circuit GD1 and even-numbered scanning lines G may be connected to the scanning line drive circuit GD2. In addition, the signal line drive circuit SD, the scanning line drive circuit GD, and the common electrode drive circuit CD may be formed on the first substrate SUB1 or several parts or all the parts of the circuits may be built in the IC chip I1 shown in FIG. 3.

Each pixel PX includes a switching element SW, a pixel electrode PE, the common electrode CE, a liquid crystal layer LC, and the like. The switching element SW is formed of, for example, a thin-film transistor (TFT) and is electrically connected to the scanning line G and the signal line S. More specifically, the switching element SW includes a gate electrode WG, a source electrode WS, and a drain electrode WD. The gate electrode WG is electrically connected to the scanning line G. In the example illustrated, an electrode electrically connected to the signal line S is referred to as the source electrode WS, and an electrode electrically connected to the pixel electrode PE is referred to as the drain electrode WD.

The scanning line G is connected to the switching element SW of each of the pixels PX arranged in the first direction X. The signal line S is connected to the switching element SW of each of the pixels PX arranged in the second direction Y. Each pixel electrode PE is opposed to the common electrode CE, and drives the liquid crystal layer LC by an electric field which is produced between the pixel electrode PE and the common electrode CE. A storage capacitor CS is formed, for example, between the common electrode CE and the pixel electrode PE.

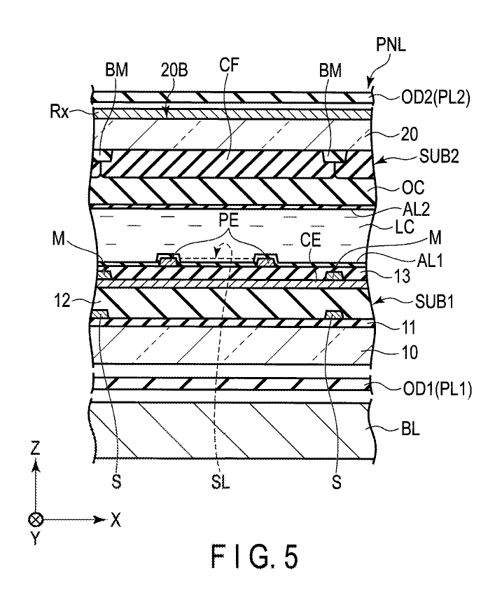

FIG. 5 is a cross-sectional view showing a partial structure of the display panel PNL shown in FIG. 3. A cross-section of the display device DSP seen along the first direction X is illustrated.

As shown in FIG. 5, the illustrated display panel PNL has a configuration corresponding to a display mode primarily using a lateral electric field approximately parallel to a main surface of a substrate. The display panel PNL may have a configuration conforming to a display mode using a longitudinal electric field perpendicular to the main surface of the substrate, an electric field inclined to the main surface, or a combination of the electric fields. In the display mode using the lateral electric field, for example, it is possible to apply such a structure where the first substrate SUB1 or the second substrate SUB2 includes both the pixel electrode PE and the common electrode CE. In the display mode using the lateral electric field or the inclined electric field, for example, a structure comprising either of the pixel electrode PE and the common electrode CE on the first substrate SUB1 and comprising the other of the pixel electrode PE and the common electrode CE on the second substrate SUB2 can be applied. The main surface of the substrate is a surface parallel to the X-Y plane.

The first substrate SUB1 comprises the first glass substrate 10, the signal lines S, the common electrode CE, the metal layers M, the pixel electrodes PE, a first insulating film 11, a second insulating film 12, a third insulating film 13, a first alignment film AL1, and the like. The switching elements, scanning lines, and various insulating layers interposed between the elements and lines are not illustrated.

The first insulating film 11 is located on the first glass substrate 10. Semiconductor layers of switching elements (not shown) and the scanning lines are located between the first glass substrate 10 and the first insulating film 11. The signal lines S are located on the first insulating film 11. The second insulating film 12 is located on the signal lines S and the first insulating film 11. The common electrode CE is located on the second insulating film 12. The metal layer M is in contact with the common electrode CE directly above the signal line S. In the example illustrated, the metal layer M is located on the common electrode CE but may be located between the common electrode CE and the second insulating film 12. The third insulating film 13 is located on the common electrode CE and the metal layers M. The pixel electrodes PE are located on the third insulating film 13. The pixel electrodes PE are opposed to the common electrode CE via the third insulating film 13. In addition, each pixel electrode PE includes a slit SL at a position opposed to the common electrode CE. The first alignment film AL1 covers the pixel electrodes PE and the third insulating film 13.

The scanning lines, the signal lines S, and the metal layers M are formed of metals such as molybdenum, tungsten, titanium and aluminum and may be formed in a single-layer structure or a multi-layer structure. For example, the scanning lines are formed of a metal material containing molybdenum and tungsten, the signal lines S are formed of metal materials containing titanium and aluminum, the metal layer M is formed of metal materials composed of molybdenum and aluminum, and the scanning lines, the signal lines S, and the metal layers M are formed of different materials. The common electrode CE and the pixel electrodes PE are formed of a transparent conductive material such as ITO or IZO. The first insulating film 11 and the third insulating film 13 are inorganic insulating films while the second insulating film 12 is an organic insulating film.

The constitution of the first substrate SUB1 is not limited to the example illustrated but the pixel electrodes PE may be located between the second insulating film 12 and the third insulating film 13, and the common electrode CE may be located between the third insulating film 13 and the first alignment film AL1. In this case, the pixel electrodes PE are shaped in a flat plate including no slits while the common electrode CE includes slits opposed to the pixel electrodes PE. In addition, the pixel electrodes PE and the common electrode CE may be shaped in combs and disposed to be engaged with each other.

The second substrate SUB2 includes the second glass substrate 20, a light-shielding layer BM, a color filter CF, an overcoat layer OC, a second alignment film AL2, and the like.

The light-shielding layer BM and the color filter CF are located on a side of the second glass substrate 20 which is opposed to the first substrate SUB1. The light-shielding layer BM sections the pixels and is located directly above the signal lines S. The color filter CF is opposed to the pixel electrode PE and partially overlaps the light-shielding layer BM. The color filter CF includes a red color filter, a green color filter, a blue color filter, and the like. The overcoat layer OC covers the color filter CF. The second alignment film AL2 covers the overcoat layer OC.

The color filter CF may be disposed on the first substrate SUB1. The color filter CF may include color filters of four or more colors. On a pixel displaying a white color, a white color filter or an uncolored resin material may be disposed or the overcoat layer OC may be disposed without disposing the color filter.

The detection electrode Rx is located on the main surface 20B of the second glass substrate 20. The detection electrodes Rx may be composed of a conductive layer containing a metal, formed of a transparent conductive material such as ITO or IZO, formed by depositing a transparent conductive layer on a conductive layer containing a metal, or formed of a conductive organic material or a dispersing element of a fine conductive substance, and the like.

A first optical element OD1 including a first polarizer PL1 is located between the first glass substrate 10 and an illumination device BL. A second optical element OD2 including a second polarizer PL2 is located on the detection electrode Rx. Each of the first optical element OD1 and the second optical element OD2 may include a retardation film as needed.

Next, a configuration example of the sensor SS mounted on the display device DSP of the present embodiment will be described. The sensor SS explained below is, for example, a capacitive sensor of a mutual-capacitive type, which detects contact or approach of an object, based on the variation in electrostatic capacitance between a pair of electrodes opposed via a dielectric.

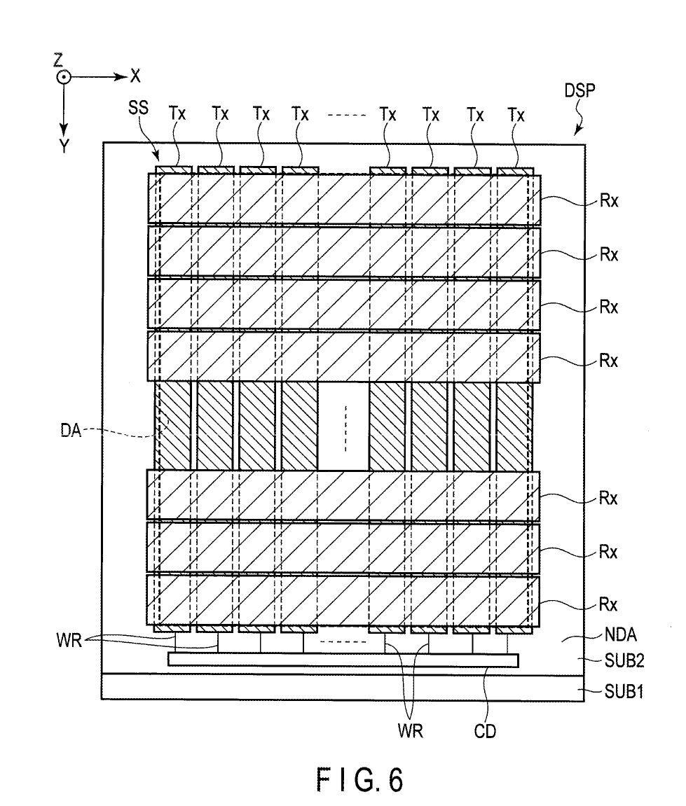

FIG. 6 is a plan view showing a configuration example of the sensor SS.

As shown in FIG. 6, the sensor SS comprises sensor drive electrodes Tx serving as drive electrodes and the detection electrodes Rx in the configuration example illustrated. In the example illustrated, the sensor drive electrodes Tx correspond to portions indicated by downward-sloping hatch lines and are provided on the first substrate SUB1. The detection electrodes Rx correspond to portions indicated by upward-sloping hatch lines and are provided on the second substrate SUB2. The sensor drive electrodes Tx and the detection electrodes Rx intersect each other in the X-Y plane. The detection electrodes Rx are opposed to the sensor drive electrodes Tx in the third direction Z.

The sensor drive electrodes Tx and the detection electrodes Rx are located in the display area DA and several parts of the electrodes extend to the non-display area NDA. In the example illustrated, the sensor drive electrodes Tx are formed in a strip shape extending in the second direction Y and arranged so as to be spaced apart from each other in the first direction X. The detection electrodes Rx extend in the first direction X and are spaced apart from each other in the second direction Y. The detection electrodes Rx are connected to the conductive layer CL provided on the first substrate SUB1 and electrically connected with the detection circuit RC via the leads W as explained with reference to FIG. 3. Each of the sensor drive electrodes Tx is electrically connected with the common electrode drive circuit CD via a lead-out line WR. The number, size and shape of the sensor drive electrodes Tx and the detection electrodes Rx are not particularly limited but can be variously changed.

In the present embodiment, the above-explained common electrode CE is employed as the sensor drive electrode Tx. The sensor drive electrodes Tx are the common electrodes CE. The sensor drive electrodes Tx (common electrodes CE) have a function of urging an electric field to be generated between the own electrodes and the pixel electrodes PE and a function of detecting the position of the object by generating the capacitance between the own electrodes and the detection electrodes Rx.

The common electrode drive circuit CD supplies the common drive signals to the sensor drive electrodes Tx at the display driving period to display images in the display area DA. In addition, the common electrode drive circuit CD supplies the sensor drive signals to the sensor drive electrodes Tx at the sensing driving period to execute sensing. The detection electrodes Rx output sensor signals necessary for sensing (i.e., signals based on variation in inter-electrode capacitance between the sensor drive electrodes Tx and the detection electrodes Rx) in accordance with the supply of the sensor drive signals to the sensor drive electrodes Tx. The detection signals output from the detection electrodes Rx are input to the detection circuit RC shown in FIG. 3.

The sensor SS in each of the above-explained configuration examples is not limited to a mutual-capacitive sensor which detects the object, based on the variation in electrostatic capacitance between a pair of electrodes (in the above case, the electrostatic capacitance between the sensor drive electrodes Tx and the detection electrodes Rx), but may be a self-capacitive sensor which detects the object, based on the variation in electrostatic capacitance of the detection electrodes Rx.

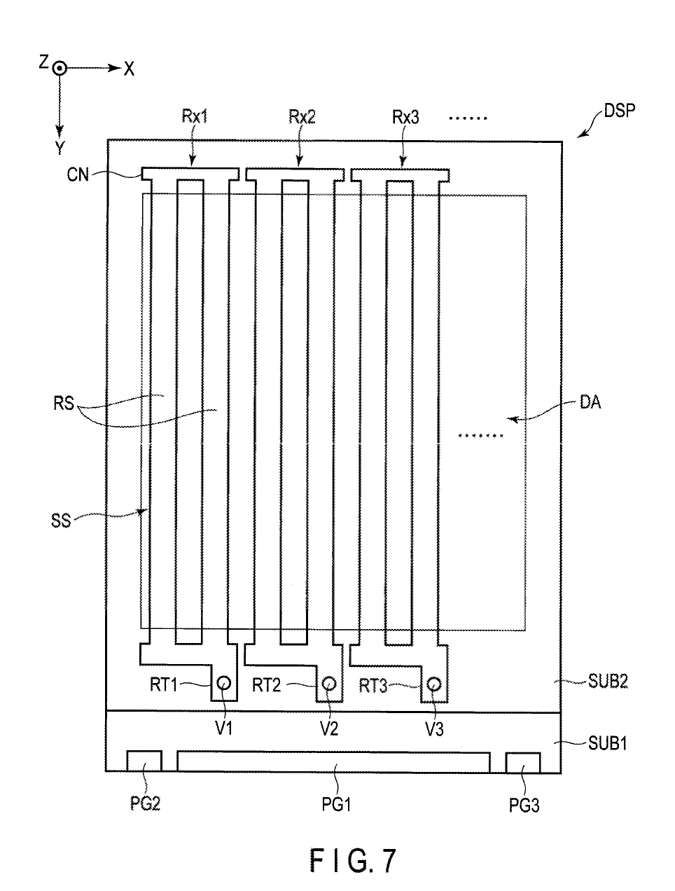

FIG. 7 is a plan view showing another configuration example of the display device DSP according to the present embodiment. The configuration example shown in FIG. 7 is different from the configuration example shown in FIG. 3 with respect to a feature that the detection electrodes Rx1, Rx2, Rx3, . . . extend in the second direction Y and are arranged in the first direction X so as to be spaced apart from each other. In the example illustrated, the detectors RS extend in the second direction Y in the display area DA. In addition, the terminals RT1, RT2, RT3, . . . are arranged between the display area DA and the first pad group PG1 in the first direction X and spaced apart from each other. The contact holes V1, V2, V3, . . . are arranged in the first direction X and spaced apart from each other. The display device DSP may comprise sensor drive electrodes extending in the first direction X so as to be arranged in the second direction Y and spaced apart from each other, although not illustrated in the drawing.

The configuration example shown in FIG. 7 is applicable to the self-capacitive sensor SS using the detection electrodes Rx and is also applicable to the mutual-capacitive sensor SS using the detection electrodes Rx and sensor drive electrodes (not shown).

FIG. 8 is an illustration showing a configuration example of the detector RS in the detection electrode Rx1 shown in FIG. 3 and FIG. 7.

In the example shown in FIG. 8(A), the detector RS is formed of mesh-shaped fine metal wires MS. The fine metal wires MS are joined to the terminal RT1. In the example shown in FIG. 8(B), the detector RS is formed of wave-shaped fine metal wires MW. In the example illustrated, the fine metal wires MW are formed in a sawtooth shape but may be in the other shape such as a sine wave shape. The fine metal wires MW are joined to the terminal RT1.

The terminal RT1 is formed of, for example, the same material as the detector RS. A circular contact hole V1 is formed in the terminal RT1.

FIG. 9 is a cross-sectional view showing the display panel PNL including a connection hole V1 shown in FIG. 3 as sectioned in line IX-IX. Only main portions necessary for explanations are illustrated in the drawing.

As shown in FIG. 9, the first substrate SUB1 includes the first glass substrate 10, the conductive layer CL1, the second insulating film 12 corresponding to the organic insulating film, and the like. The first conductive layer CL1 is formed of, for example, the same material as the signal lines S shown in FIG. 5. The first insulating film 11 shown in FIG. 5, the other insulating film or the other conductive layer may be disposed between the first glass substrate 10 and the conductive layer CL1, and between the first glass substrate 10 and the second insulating film 12.

The second substrate SUB2 includes the second glass substrate 20, the detection electrode Rx1, the light-shielding layer BM and the overcoat layer OC corresponding to the organic insulating films, and the like.

The sealing member SE corresponds to the organic insulating film and is located between the second insulating film 12 and the overcoat layer OC. The liquid crystal layer LC is located in the gap between the first substrate SUB1 and the second substrate SUB2. The metal layers M, the third insulating film 13, and the first alignment film AL1 shown in FIG. 5 may be interposed between the second insulating film 12 and the sealing member SE, although not illustrated in the drawing. Alternatively, the second alignment film AL2 shown in FIG. 5 may be interposed between the overcoat layer OC and the sealing member SE.

The connection hole V1 includes the through hole VA which penetrates the second glass substrate 20 and the terminal RT of the detection electrode Rx, the through hole VB which penetrates the conductive layer CL1, the through hole VC which penetrates various organic insulating layers, and the concavity CC formed in the first glass substrate 10. The through hole VC includes a first part VC1 which penetrates the second insulating film 12, a second part VC2 which penetrates the sealing member SE, and a third part VC3 which penetrates the light-shielding layer BM and the overcoat layer OC. The connecting member C is provided in the connection hole V1 to electrically connect the detection electrode Rx with the conductive layer CL1.

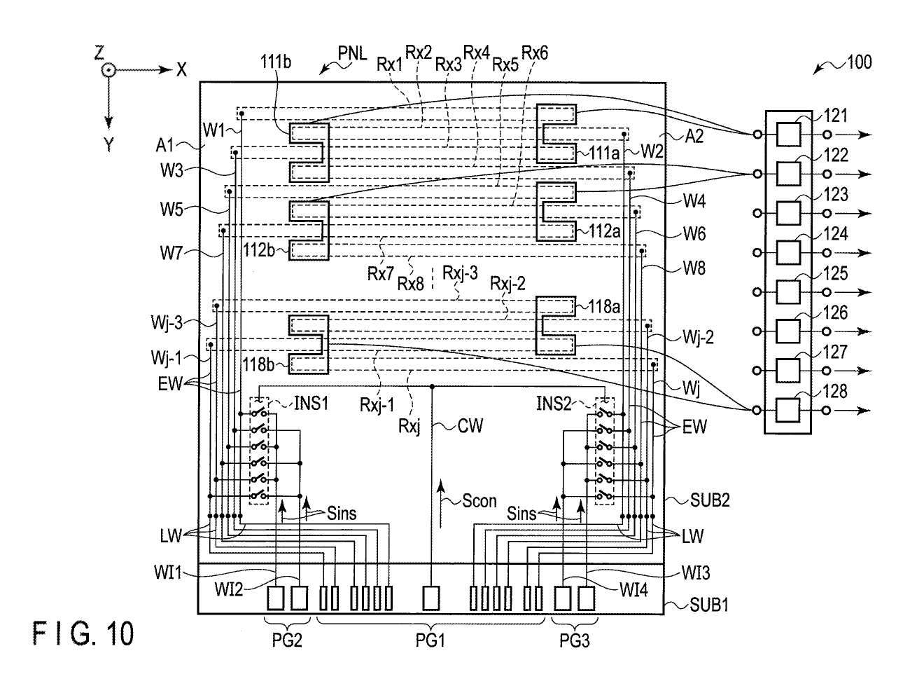

FIG. 10 is a plan view showing the display panel PNL according to the embodiment, together with an inspection device of the display panel PNL.

As shown in FIG. 10, each of the leads W includes an extending line EW and a routed line LW. The extending line EW is located on the first insulating film 11 and covered with the second insulating film 12, and extends substantially parallel to the signal lines S. When a first line is substantially parallel to a second line in the present specification, the first line extends not only parallel to the second line, but the first line is inclined to the second line at an angle greater than zero degrees and smaller than and equal to twenty degrees. In the present embodiment, the extending line EW extends in the second direction Y, similarly to the signal lines S.

The routed line LW is formed on the second insulating film 12 and covered with the third insulating film 13. The routed line LW includes an end connected to the extending line EW and another end connected to one of the pads of the first pad group PG1. For example, the end of the routed line LW is opposed to the extending line EW and is in contact with the extending line EW through the contact hole formed in the second insulating film 12.

The inspection circuit INS1 serving as the first inspection circuit is located in the non-display area NDA and is connected to the extending lines EW (leads W). The inspection circuit INS2 serving as the second inspection circuit is located in the non-display area NDA and is connected to the extending lines EW (leads W). For example, the inspection circuit INS1 is located on the first area A1 side, and the inspection circuit INS2 is located on the second area A2 side.

The first substrate SUB1 includes a plurality of inspection lines WI. In the present embodiment, the first substrate SUB1 includes four inspection lines WI1, WI2, WI3, and WI4. The inspection lines WI1 and WI2 connect the inspection circuit INS1 with the pads of the second pad group PG2. The inspection lines WI3 and WI4 connect the inspection circuit INS2 with the pads of the third pad group PG3.

The size of each of the pads of the second pad group PG2 and the third pad group PG3 connected to the inspection lines WI is larger than the size of each of the pads connected to the routed lines LW (leads W), of the pads of the first pad group PG1, in planar view. A proportion of the size between the pads is not particularly limited but, in the present embodiment, the size of each of the pads of the second pad group PG2 and the third pad group PG3 is approximately four times as large as the size of each of the pads connected to the routed lines LW.

The first substrate SUB1 includes a control line CW. The control line CW is connected to the inspection circuit INS1, the inspection circuit INS2, and the pad of the first pad group PG1. The size of the pad connected to the control line CW is substantially the same as the size of each of the pads of the second pad group PG2 and the third pad group PG3. When one pad size is substantially the same as another pad size, one pad size is not only completely the same as the other pad size, but the other pad size is slightly different from one pad size, i.e., approximately 0.9 to 1.1 times as large as one pad size.

As described above, if the size of the pad connected to the control line CW of the first pad group PG1 and the size of each of the pads of the second pad group PG2 and the third pad group PG3 become larger, these pads can be used as the inspection pads and the area of the pads required when probing is executed can be obtained.

Each of the inspection circuits INS1 and INS2 comprises a plurality of switches. The switches of the inspection circuits INS are constituted by TFT, similarly to the switching elements SW of the pixels PX. In the present embodiment, the switches of the inspection circuits INS are constituted by TFT of the same conductive type. For this reason, the switches of the inspection circuits INS are simultaneously changed to the conductive state (on) or the nonconductive state (off), based on a control signal Scon supplied via the pad of the first pad group PG1, the control line CW, and the like. Alternatively, the same signal as the control signal supplied to the switching elements to which the video signals for inspection are written may be used instead of the control line CW.

In addition, j detection electrodes Rx1, Rx2, . . . , Rxj-1, and Rxj are assumed to be provided on the second substrate SUB2. The number j is an integer greater than or equal to two.

In the drawing, each of the detection electrodes Rx1, Rx5, and Rxj-3 is connected to the inspection line WI1 via the corresponding lead W and the corresponding switch of the inspection circuit INS1. Each of the detection electrodes Rx3, Rxj, and Rxj-1 is connected to the inspection line WI2 via the corresponding leads W and the corresponding switch of the inspection circuit INS1.

Each of the detection electrodes Rx2, Rx6, and Rxj-2 is connected to the inspection line WI3 via the corresponding lead W and the corresponding switch of the inspection circuit INS2. Each of the detection electrodes Rx4, Rx8, and Rxj is connected to the inspection line WI2 via the corresponding lead W and the corresponding switch of the inspection circuit INS2.

The detection electrodes Rx and the extending lines EW (leads W) configured as explained above can be inspected by the inspection circuits INS1 and INS2, and the non-contact type inspection device 100. Conduction of such an inspection at a step of the manufacturing process can contribute to the formation of the display panel PNL having a high product yield.

The inspection device 100 comprises a plurality of sensors and a plurality of detectors. The sensors are configured to sense electric potentials of the detection electrodes Rx in a non-contact manner. For example, the sensors are configured to sense the electrostatic capacitance between the sensors and the detection electrodes Rx. Alternately, the sensors may be configured to sense information on secondary electrons emitted from the detection electrodes Rx by applying an electron beam to the detection electrodes Rx.

In the present embodiment, a sensor 111a of the inspection device 100 is opposed to ends of the detection electrodes Rx1 and Rx3 on the second area A2 side. A sensor 111b of the inspection device 100 is opposed to ends of the detection electrodes Rx2 and Rx4 on the first area A1 side. Similarly, sensors 112a, 112b, 118a, and 118b of the inspection device 100 are opposed to ends of the detection electrodes Rx.

In the present embodiment, the inspection device 100 comprises eight detectors 121, 122, 123, 124, 125, 126, 127, and 128. In other words, the inspection device 100 can conduct inspection by using eight physical channels (8 ch). Information sensed by the sensors 111a and 111b is input to the detector 121 of the inspection device 100. Information sensed by the sensors 112a and 112b is input to the detector 122 of the inspection device 100. Information sensed by the sensors 118a and 118b is input to the detector 128 of the inspection device 100.

Next, an inspection method using the inspection device 100 will be explained.

When the inspection is started, the detectors 121 to 128 are first opposed to the detection electrodes Rx. Then, probing of the pad of the first pad group PG1 which is connected to the control line CW, the pads of the second pad group PG2, and the pads of the third pad group PG3 is executed prior to connecting the wiring substrate 1 to the first substrate SUB1. The control signal Scon can be supplied to the control line CW and inspection signals Sins can be supplied to the inspection lines WI, by executing probing as explained above. After that, the control signal Scon is supplied to each of the inspection circuits INS1 and INS2 via the control line CW and the like, and all the switches of the inspection circuits INS1 and INS2 are changed to a conductive state.

Next, the inspection signal Sins is supplied to the inspection line WI1, and the electric potentials of the extending lines EW (leads W) and the detection electrodes Rx connected to the inspection line WI1 are varied. At this time, the inspection lines WI2, WI3, and WI4 are fixed to the ground potential, and the electric potentials of the extending lines EW (leads W) and the detection electrodes Rx connected to the inspection lines WI2, WI3, and WI4 are not varied but fixed. The information of the lead W1 and the detection electrode Rx1 can be thereby sensed by the sensor 111a and the detector 121. The information of the lead W5 and the detection electrode Rx5 can be thereby sensed by the sensor 112a and the detector 122. The information of the lead Wj-3 and the detection electrode Rxj-3 can be thereby sensed by the sensor 118a and the detector 128.

The above information includes information on break, electric resistance values, and the like of the extending line EW (lead W) and the detection electrode Rx.

Alternatively, the inspection signal Sins is supplied to the inspection line WI2, and the electric potentials of the extending lines EW (leads W) and the detection electrodes Rx connected to the inspection line WI2 are varied. At this time, the electric potentials of the extending lines EW (leads W) and the detection electrodes Rx connected to the inspection lines WI1, WI3, and WI4 are not varied but fixed. The information of the lead W3 and the detection electrode Rx3 can be thereby sensed by the sensor 111a and the detector 121. The information of the lead W7 and the detection electrode Rx7 can be thereby sensed by the sensor 112a and the detector 122. The information of the lead Wj-1 and the detection electrode Rxj-1 can be thereby sensed by the sensor 118a and the detector 128.

Alternatively, the inspection signal Sins is supplied to the inspection line WI3, and the electric potentials of the extending lines EW (leads W) and the detection electrodes Rx connected to the inspection line WI3 are varied. At this time, the electric potentials of the extending lines EW (leads W) and the detection electrodes Rx connected to the inspection lines WI1, WI2, and WI4 are not varied but fixed. The information of the lead W2 and the detection electrode Rx2 can be thereby sensed by the sensor 111b and the detector 121. The information of the lead W6 and the detection electrode Rx6 can be thereby sensed by the sensor 112b and the detector 122. The information of the lead Wj-2 and the detection electrode Rxj-2 can be thereby sensed by the sensor 118b and the detector 128.

Alternatively, the inspection signal Sins is supplied to the inspection line WI4, and the electric potentials of the extending lines EW (leads W) and the detection electrodes Rx connected to the inspection line WI4 are varied. At this time, the electric potentials of the extending lines EW (leads W) and the detection electrodes Rx connected to the inspection lines WI1, WI2, and WI3 are not varied but fixed. The information of the lead W4 and the detection electrode Rx4 can be thereby sensed by the sensor 111b and the detector 121. The information of the lead W8 and the detection electrode Rx8 can be thereby sensed by the sensor 112b and the detector 122. The information of the lead Wj and the detection electrode Rxj can be thereby sensed by the sensor 118b and the detector 128.

The inspection can be executed as explained above.

In the above-explained embodiment, two inspection lines WI are connected to each of the inspection circuits INS, but are not limited. The number of the inspection lines WI may be adjusted in accordance with the number (j) of the detection electrodes Rx. One inspection line WI may be connected to each of the inspection circuits INS. In this case, each of the sensors of the inspection device 100 is opposed to the end of one detection electrode Rx. Alternatively, three or more inspection line WI may be connected to each of the inspection circuits INS. For example, when three inspection lines WI are connected to each of the inspection circuits INS, the sensors of the inspection device 100 are opposed to the ends of three detection electrodes Rx.

Response to the inspection can be made without changing the number of the physical channels of the inspection device 100 to more than eight by adjusting the configuration of the inspection circuits INS, the inspection lines WI, and the like.

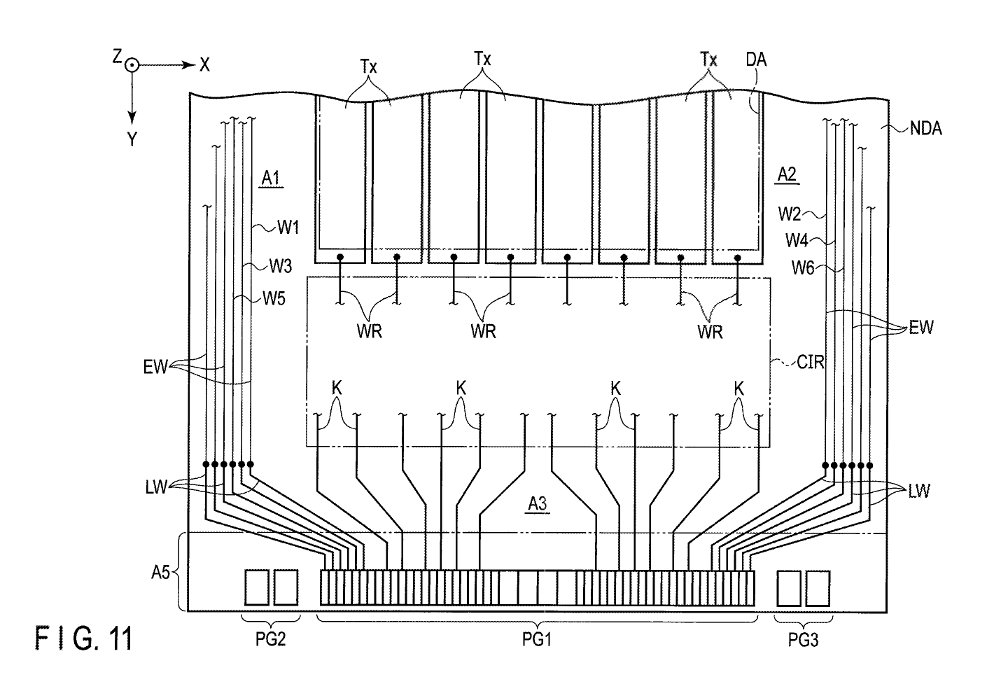

FIG. 11 is a plan view showing several parts of the first substrate SUB1 according to the embodiment.

As shown in FIG. 11, the first substrate SUB1 includes a plurality of connection lines K and a plurality of lead-out lines WR. The connection lines K are formed on the second insulating film 12, located in the third area A3 of the non-display area NDA, and connected to the pads of the first pad group PG1. In contrast, the connection lines K are electrically connected to the signal lines S via the signal line drive circuit SD of the circuit group CIR. The lead-out lines WR are formed on the second insulating film 12, located in the third area A3 of the non-display area NDA, and connected to the sensor drive electrodes Tx. In contrast, the lead-out lines WR are electrically connected to the common electrode drive circuit CD of the circuit group CIR.

In the drawing, all the routed lines LW, the connection lines K, and the lead-out lines WR are formed on the second insulating film 12. In the present embodiment, all the routed lines LW, the connection lines K, and the lead-out lines WR are formed of the same metal as the metal layer M.

The routed lines LW and the connection lines K adjacent to each other extend substantially parallel to each other. For example, the left-end connection line K and the routed line LW of the lead W1 extend substantially parallel to each other. In addition, the right-end connection line K and the routed line LW of the lead W2 extend substantially parallel to each other. The routed lines LW and the connection lines K are formed in the same layer for the purpose of being connected to the same first pad group PG1. Then, the lines are connected to effectively use the third area A3 and lay the routed lines LW and the connection lines K.

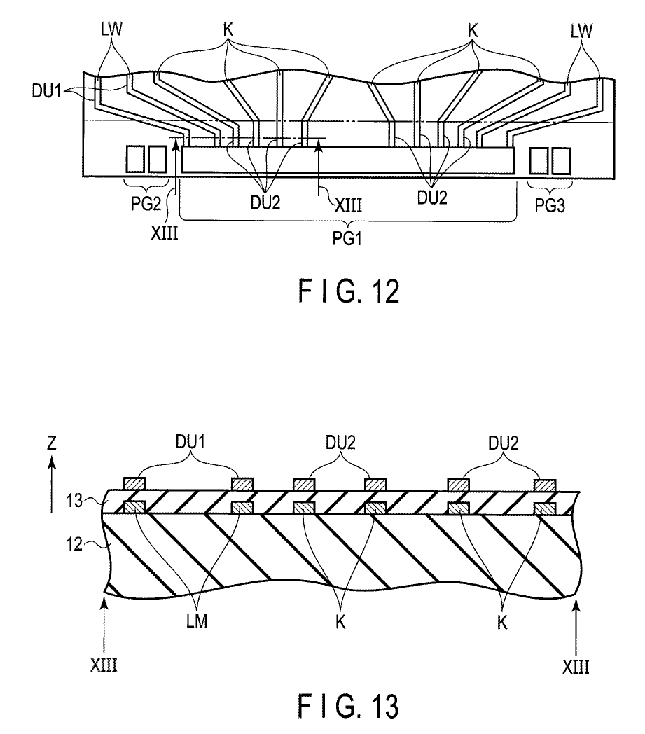

FIG. 12 is another plan view showing several parts of the first substrate SUB1 according to the embodiment. FIG. 13 is a cross-sectional view showing the first substrate SUB1 along line XIII-XIII in FIG. 12.

As shown in FIG. 12 and FIG. 13, the first substrate SUB1 includes first dummy lines DU1 and second dummy lines DU2. The first dummy lines DU1 and the second dummy lines DU2 are located on the third insulating film 13 and formed of transparent conductive materials. In the present embodiment, the first dummy lines DU1 and the second dummy lines DU2 are located in the same layer as the pixel electrodes PE and also formed of the same materials as those of the pixel electrodes PE.

The first dummy lines DU1 are opposed to the routed lines LW and extend along the routed lines LW. The second dummy lines DU2 are opposed to the connection lines K and extend along the connection lines K. The first dummy lines DU1 may be opposed to the routed lines LW and extend along the routed lines LW in at least the unopposed area A5 (i.e., an area which is not opposed to the second substrate SUB2, on the first substrate SUB1). Similarly, the second dummy lines DU2 may be opposed to the connection lines K and extend along the connection lines K in at least the unopposed area A5.

In the present embodiment, the width of each of the first dummy lines DU1 is equal to the width of each of the routed lines LW. Positions of edges of the first dummy lines DU1 and the routed lines LW are aligned in the third direction Z. Similarly, the width of each of the second dummy lines DU2 is equal to the width of each of the connection lines K. Positions of edges of the second dummy lines DU2 and the connection lines K are aligned in the third direction Z.

However, a relationship between the first dummy lines DU1 and the routed lines LW and a relationship between the second dummy lines DU2 and the connection lines K are not limited to the above examples. For example, the first dummy lines DU1 may not be completely opposed to the routed lines LW in the third direction Z and may be opposed to at least several parts of the routed lines LW in the third direction Z. In addition, the width of each of the first dummy lines DU1 may be smaller than the width of each of the routed lines LW or may be larger than the width of each of the routed lines LW.

The first dummy lines DU1 and the second dummy lines DU2 are provided on the third insulating film 13 so as to be spaced apart. The first dummy lines DU1 and the second dummy lines DU2 are not electrically connected to the other conductive members. For this reason, the first dummy lines DU1 and the second dummy lines DU2 are in an electrically floating state.

As explained above, the first dummy lines DU1 are provided above the routed lines LW and the second dummy lines DU2 are provided above the connection lines K, in the unopposed area A5. For this reason, corrosion which may occur on the routed lines LW and the connection lines K can be suppressed as compared with a case where the first dummy lines DU1 and the second dummy lines DU2 are not provided.

In addition, the first dummy lines DU1 and the second dummy lines DU2 are in an electrically floating state. For this reason, the first dummy lines DU1 and the second dummy lines DU2 can electrically shield the routed lines LW and the connection lines K.

According to the display device DSP of the embodiment constituted as explained above, the display device DSP comprises the first substrate SUB1, the second substrate SUB2, the connection hole V1, and the connecting member C. The first substrate SUB1 includes the first glass substrate 10, the sensor drive electrodes Tx located in the display area DA, the conductive layer CL1 located in the non-display area NDA outside the display area DA, the lead W1 located in the non-display area NDA and connected to the conductive layer CL1, and the inspection circuit INS1 located in the non-display area NDA and connected to the lead W1. The second substrate SUB2 includes the second glass substrate 20 opposed to the first glass substrate 10 and the sensor drive electrodes Tx, and the detection electrode Rx1 opposed to the conductive layer CL1 to intersect the sensor drive electrodes Tx. The connection hole V1 penetrates at least the second glass substrate 20. The connecting member C electrically connects the detection electrode Rx1 with the conductive layer CL1 via the connection hole V1.

In the manufacturing of the display device DSP, the lead W1 and the detection electrode Rx1 can be inspected by the inspection circuit INS1. For this reason, the display device DSP having a high product yield can be obtained.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, the positional relationship between the conductive layer CL and the connection hole V is not limited to that in the above-described embodiment but can be variously modified.

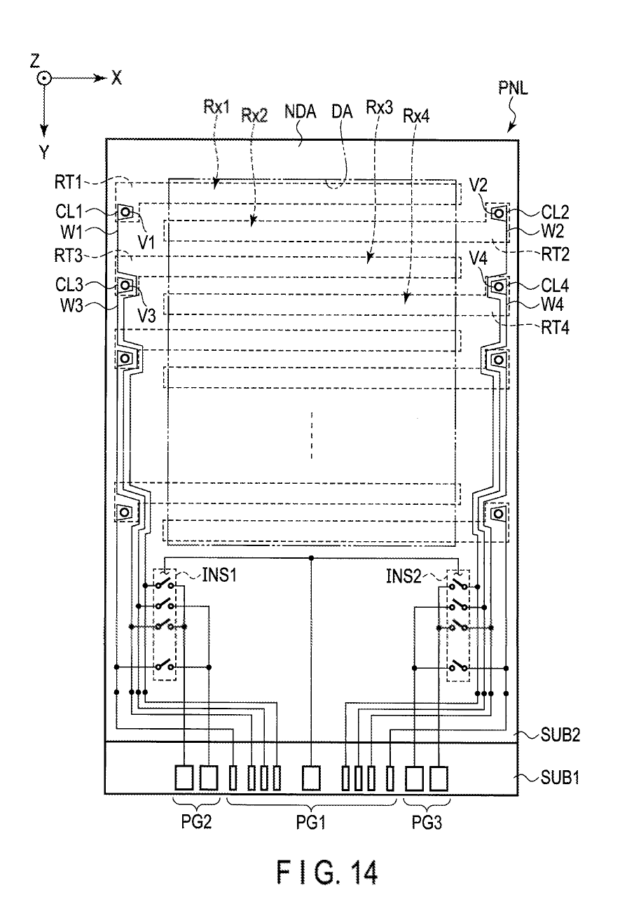

As shown in FIG. 14, a pair of the conductive layer CL1 and the connection hole V1 and a pair of the conductive layer CL2 and the connection hole V2 may be located across the display area DA in the first direction X in which the detection electrodes Rx1 and Rx2 extend, and located in the same straight line parallel to the first direction X. In this case, the terminal RT1 of the detection electrode Rx1 and the terminal RT2 of the detection electrode Rx2 are located in the same straight line parallel to the first direction X.

Besides, a pair of the conductive layer CL3 and the connection hole V3 and a pair of the conductive layer CL4 and the connection hole V4 are located across the display area DA in the first direction X in which the detection electrodes Rx3 and Rx4 extend, and located in the same straight line parallel to the first direction X. In this case, too, the terminal RT3 of the detection electrode Rx3 and the terminal RT4 of the detection electrode Rx4 are located in the same straight line parallel to the first direction X.

A layout of the first area A1 and a layout of the second area A2 can be designed symmetrically with respect to the display area DA. For example, the scanning line drive circuits GD1 and GD2 can be configured to have bilateral symmetry.

What is claimed is:

1. A display device comprising:
a first substrate including a first insulating substrate, a drive electrode located in a display area, a first conductive layer located in a non-display area outside the display area, a first lead located in the non-display area and connected to the first conductive layer, and a first inspection circuit located in the non-display area and connected to the first lead;
a second substrate including a second insulating substrate opposed to the first insulating substrate and the drive electrode, and a first detection electrode opposed to the first conductive layer to intersect the drive electrode;
a first connection hole penetrating the second insulating substrate; and
a connecting member electrically connecting the first detection electrode with the first conductive layer via the first connection hole.

2. The display device of claim 1, further comprising:
a wiring substrate connected to the first substrate,
wherein
the first substrate further includes an inspection line, a first pad group located in the non-display area, opposed to the wiring substrate, and connected with the wiring substrate, and a second pad group located in the non-display area, spaced apart from the first pad group and not connected with the wiring substrate,
the first lead is connected to a pad of the first pad group, and
the inspection line connects the first inspection circuit with a pad of the second pad group.

3. The display device of claim 2, wherein
a size of the pad connected to the inspection line in the second pad group is larger than a size of the pad connected to the first lead in the first pad group, in planar view.

4. The display device of claim 2, wherein
the first substrate further includes:
a first insulating film;
a signal line located in the display area and formed on the first insulating film;
a second insulating film formed on the first insulating film and the signal line; and
a connection line formed on the second insulating film, located in the non-display area, connected to a pad of the first pad group, and electrically connected to the signal line, and
the first lead includes:
an extending line formed on the first insulating film and extending substantially parallel to the signal line; and
a routed line formed on the second insulating film and including an end connected to the extending line and another end connected to the pad of the first pad group, and
the routed line and the connection line adjacent to each other extend substantially parallel to each other.

5. The display device of claim 4, wherein
the routed line and the connection line are formed of a metal.

6. The display device of claim 5, wherein
the first substrate further includes:
a third insulating film formed on the second insulating film, the connection line, and the routed line; and
a first dummy line and a second dummy line located on the third insulating film and formed of a transparent conductive material, and
the first dummy line is opposed to the routed line and extending along the routed line, and the second dummy line is opposed to the connection line and extends along the connection line, in an area not opposed to the second substrate.

7. The display device of claim 6, wherein
each of the first dummy line and the second dummy line is in an electrically floating state.

8. The display device of claim 1, further comprising:
a second connection hole penetrating the second insulating substrate; and
another connecting member,
wherein
the first substrate further includes:
a second conductive layer located in the non-display area;
a second lead located in the non-display area and connected to the second conductive layer; and
a second inspection circuit located in the non-display area and connected to the second lead,
the second substrate includes a second detection electrode opposed to the second conductive layer, intersecting the drive electrode, and extending parallel to the first detection electrode,
the other connecting member electrically connects the second conductive layer with the second detection electrode via the second connection hole, and
a pair of the first conductive layer and the first connection hole and a pair of the second conductive layer and the second connection hole are located across the display area in a direction in which the first and second detection electrodes extend, and located in a same straight line parallel to the direction.

9. The display device of claim 1, further comprising:
a detection circuit electrically connected with the first lead to read a sensor signal output from the first detection electrode.
